(19) United States
(12) Patent Application Publication
(10) Pub. No.: US 2013/0320155 A1
(43) Pub. Date: Dec. 5, 2013

(54) PIPE ATTACHMENT FOR VEHICLE

(71) Applicant: SUZUKI MOTOR CORPORATION, Shizuoka (JP)

(72) Inventor: Mitsuhiro OKABE, Shizuoka (JP)

(73) Assignee: SUZUKI MOTOR CORPORATION, Shizuoka (JP)

(21) Appl. No.: 13/873,960

(22) Filed: Apr. 30, 2013

(30) Foreign Application Priority Data
May 29, 2012 (JP) 2012-121950

(51) Int. Cl. B60K 15/01

(52) U.S. Cl. CPC B60K 15/01
USPC 248/65

(57) ABSTRACT

A pipe attachment for attaching, for example, a fuel pipe to a side frame of a vehicle. The pipe has a portion extending from below a dash panel into an upper portion of an engine compartment.

The pipe attachment includes a pipe cover, a first and a second protective cover, and a pipe holder. The pipe cover is secured to the side frame between the joint of the pipe to the dash panel and an end of the pipe in the engine compartment. The first protective wall extends along the pipe and faces an inner side surface of the side frame. The second protective wall extends from the first protective wall closer to the side frame. The pipe holder is secured to a side frame opposing face of the first protective wall to retain the pipe. This structure minimizes transmission of vibration or noise from the fuel pipe inside the vehicle.

### CROSS REFERENCE TO RELATED DOCUMENT

The present application claims the benefit of priority of Japanese Patent Application No. 2012-121950 filed on May 29, 2012, the disclosure of which is totally incorporated herein by reference.

### BACKGROUND OF THE INVENTION

1. Technical Field of the Invention

The present invention relates generally to a pipe attachment for use in securing a pipe to a body of a vehicle, and more particularly to such an attachment suitable for retaining a pipe though which fuel flows and extends from below a dash panel upwardly inside an engine compartment of the vehicle.

2. Background Art

Usually, pulsation which arises from, for example, action of a fuel injector occurs at a fuel pipe or hose and may be transmitted inside a cabin of an automotive vehicle through a body thereof. In order to control such pulsation of the fuel pipe, Japanese Patent First Publication, as listed below, discloses pulsation dampers attached to clamps through which the fuel pipe is attached to a side frame of the vehicle. The pulsation dampers are each equipped with a diaphragm and a coil spring to reduce the pulsation of the fuel pipe. The publication also teaches installation of the pulsation dampers on portions of the fuel pipe corresponding to anti-nodes of a standing wave of the pulsation in order to enhance the suppression of the pulsation.

### Prior Art

### Patent Literature

Japanese Patent First Publication No. 2007-187099.

### SUMMARY OF THE INVENTION

### Problem to be Solved by the Invention

However, the structure, as taught in the above publication, attaches the fuel pipe directly to the side frame using the clamps and thus needs the pulsation dampers, thereby resulting in an increased number of parts of the structure or increased production cost thereof. The structure is also required to minimize deformation of the fuel pipe, however, there is still not any solution.

It is therefore an object of the invention to provide a pipe attachment for a vehicle which is designed to minimize transmission of mechanical vibration at, for example, a fuel pipe or noise emanating therefrom to a cabin of the vehicle, permitted to be made with a reduced number of parts at a decreased cost, and/or avoids deformation of the fuel pipe.

### Means to Solve Problem

According to one aspect of the invention, there is provided a pipe attachment for use in attaching a pipe through which fuel flows to a side frame of a vehicle. The vehicle includes an engine compartment in which an engine is mounted and a dash panel disposed on a rear side of the engine compartment in a forward-backward direction of the vehicle. The side frame is longitudinal in the forward-backward direction of the vehicle. The pipe is joined to the dash panel and has at least a portion extending from below the dash panel to an upper portion of the engine compartment. The pipe attachment comprises: (a) a pipe cover which is secured to the side frame and disposed between a joint of the pipe to the dash panel and an end of the pipe which is located inside the engine compartment; (b) a first protective wall which is a portion of the pipe cover, the first protective wall extending along the pipe and facing a side surface of the side frame which faces the engine compartment; (c) a second protective wall which is a portion of the pipe cover, the second protective wall continuing from the first protective wall and projecting toward the side frame; and (d) at least one pipe holder which is secured to a surface of the first protective wall which faces the side frame and retains the pipe.

In the preferred mode of the invention, the pipe cover may have an upper portion located above an upper surface of the side frame. The pipe holder may be joined to the upper portion of the pipe cover.

The pipe cover may have an upper end which opens to a front of the vehicle.

### Effect of the Invention

According to as aspect of the present invention, an engine is mounted in the engine compartment defined by the side frame and the dash panel. The pipe has at least a portion which extends from below the dash panel upwardly to the upper portion of the engine compartment and is secured to the side frame using the pipe cover within the engine compartment. The pipe cover includes the first protective wall, the second protective wall, and the pipe holder. The pipe cover is secured to the side frame and disposed between the joint of the pipe to the dash panel and the end of the pipe which is located inside the engine compartment. The first protective wall extends along the pipe and faces the side surface of the side frame which faces the engine compartment. The second protective wall continues from the first protective wall and projects toward the side frame. The pipe holder is secured to the surface of the first protective wall which faces the side frame and retains the pipe. The pipe cover with the pipe retained thereby is fixed to the side frame. This structure minimizes the transmission of mechanical vibration or noise from the pipe to the cabin of the vehicle and also results in a reduced number of parts of the pipe attachment and a decreased cost as compared with the case where the pipe is joined to the side frame using clamps. When the engine is moved in the backward direction of the vehicle by external force acting on the vehicle and contacts the pipe cover, the pipe cover serves to protect the pipe from direct contact with the engine, thereby minimizing the deformation of the pipe. The pipe cover also works to shield the pipe thermally from the engine to minimize a rise in temperature of the pipe. The attachment of the pipe to the side frame using clamps results in a limited degree of freedom in designing the pipe, while the use of the pipe cover offers a high degree of freedom in designing the pipe because it is easy to contour the pipe cover, especially the first protective cover to the outline of the pipe.

The pipe cover, as described above, may have the upper portion located above the upper surface of the side frame. The pipe holder may be joined to the upper portion of the pipe cover. In other words, the pipe holder is located away from the side frame, thereby improving the degree of freedom of layout of the pipe and attachment thereof to the side frame and also permitting the joint of the pipe to the side frame to be located closer to a vibrating source, i.e., the engine. This minimizes the transmission of the vibration or noise to the cabin of the vehicle through the pipe.

The pipe cover may have an upper end which opens to a front of the vehicle. The wind is, thus, introduced into the pipe cover while the vehicle is moving, thereby facilitating cooling of the pipe to avoid a rise in temperature thereof.

### BRIEF DESCRIPTION OF THE DRAWINGS

In the drawings:

FIG. 1 is a schematic view which illustrates a structure of a pipe attachment of an embodiment of the invention which attaches a fuel pipe and a fuel vapor pipe to a side frame of a vehicle;

FIG. 2 is a schematically perspective view which illustrates a fuel vapor hose and a purge hose leading to the fuel vapor pipe of FIG. 1;

FIG. 3 is a plan view which shows the inside of an engine compartment;

FIG. 4 is a side view of an engine compartment, as viewed from the right of a vehicle;

FIG. 5 is a side view of the left of a fuel pipe cover, as illustrated in FIG. 1;

FIG. 6 is a front view of the fuel pipe cover of FIG. 5;

FIG. 7 is a plan view which shows a pipe holder of the fuel pipe cover of FIGS. 5 and 6;

FIG. 8 is a front view of the pipe holder of FIG. 7;

FIG. 9 is a vertical sectional view which illustrates the pipe holder of FIGS. 7 and 8; and

FIG. 10 is a schematic view which demonstrate an engine when subjected to external force acting on a vehicle in a backward direction of the vehicle.

### DESCRIPTION OF THE PREFERRED EMBODIMENT

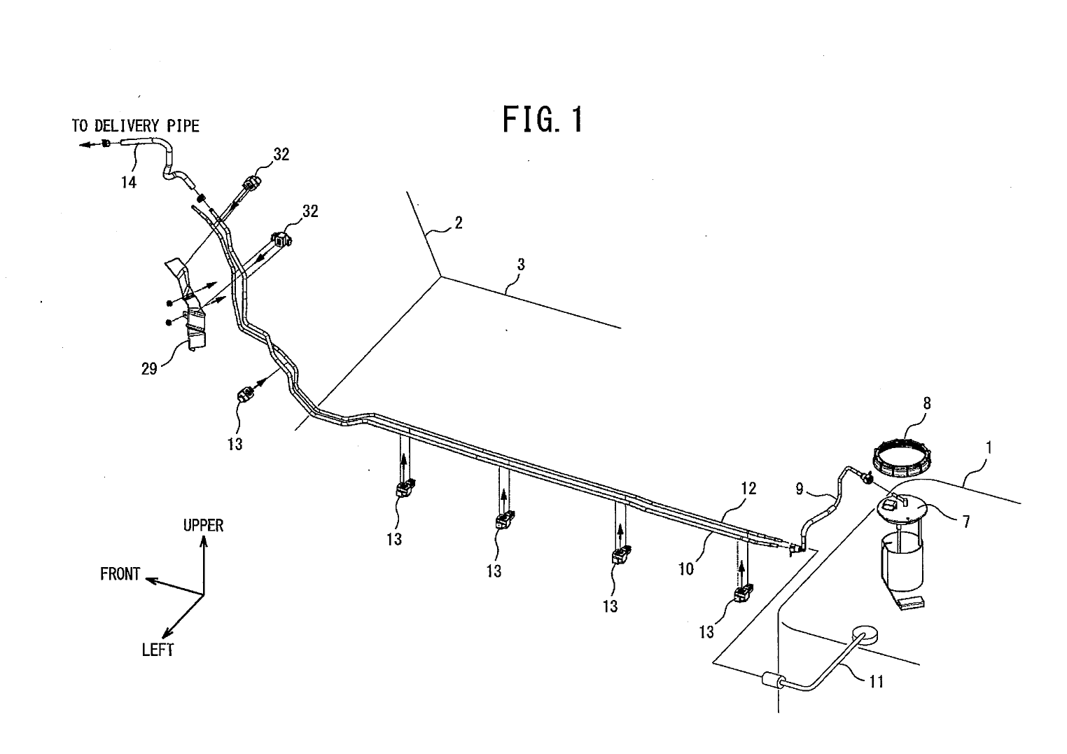

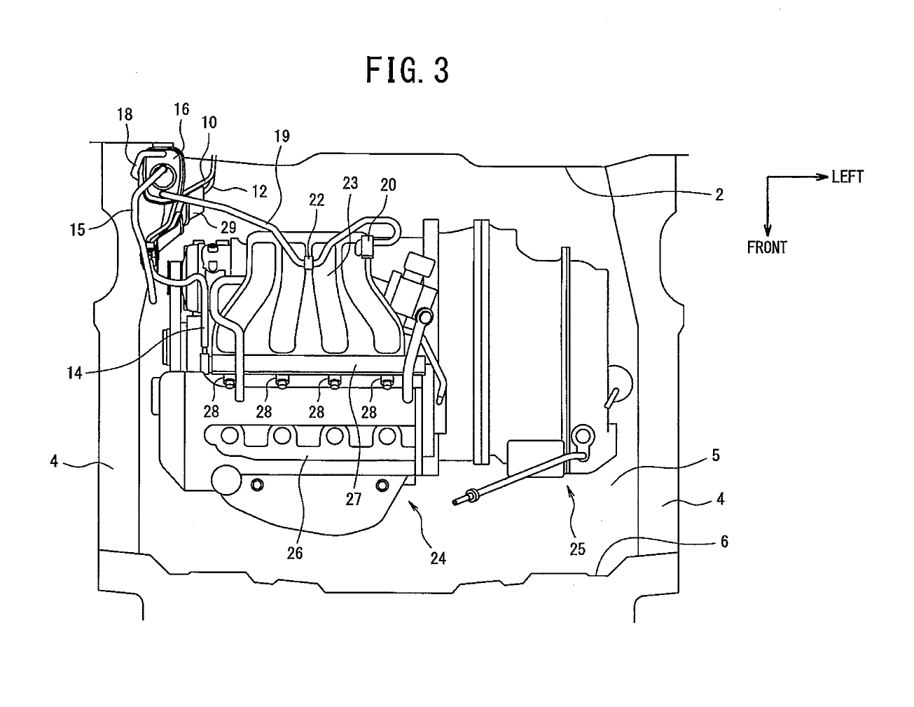

Referring to the drawings, particularly to FIG. 1, there is shown a pipe attachment for use in a vehicle according to an embodiment of the invention. FIG. 1 is a schematic view which illustrates the structure of a pipe attachment of the embodiment. The vehicle has a fuel tank 1 disposed in the rear thereof and an engine, such as an internal combustion engine, mounted in a front engine compartment 5. The engine compartment 5 is isolated by a dash panel 2 from a cabin of the vehicle. A floor panel 3 is disposed on the bottom of the cabin and forms the floor of the vehicle. The vehicle also has, as illustrated in FIG. 3, two side frames 4 which is longitudinal in a forward-backward direction thereof. The engine compartment 5 is defined by the side frames 4, the dash panel 2, and a front cross member 6.

Referring back to FIG. 1, the fuel tank 1 has disposed therein a fuel pump 7 which is firmly secured thereto through a fuel pump lock 8. The fuel pump 7 has a fuel outlet connecting with a fuel pipe 10 through a fuel pump hose 9. The fuel tank 1 has a fuel vapor outlet 11 joined to an upper wall thereof. The fuel vapor outlet 11 connects with a fuel vapor pipe 12. In the following discussion, a combination of the fuel pipe 10 and the fuel vapor pipe 12 will also be referred to as a fuel piping.

The fuel pipe 10 and the fuel vapor pipe 12 extend under the floor panel 3 toward the front of the vehicle and are bent upward from below the dash panel 2 to an upper portion of the engine compartment 5. The fuel pipe 10 and the fuel vapor pipe 12 are joined to the floor panel 3 and the dash panel 2 through pipe clamps 13. The fuel pipe 10 has an end joined in the engine compartment 5 to a delivery pipe of the engine (i.e., a cylinder head), as will be described later in detail, through a fuel hose 14.

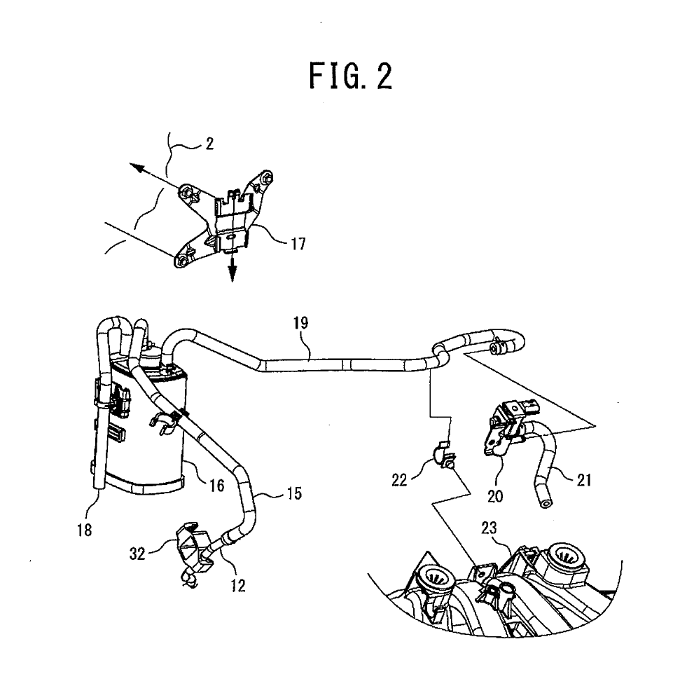

The fuel vapor pipe 12 has an end, as illustrated in FIGS. 2 and 3, which is joined in the engine compartment 5 to a fuel vapor hose 15 leading to a canister 16. The canister 16 adsorbs and captures the fuel vapor and further supplies it to a throttle valve. The canister 16 is fixed to the dash panel 2 through a canister bracket 17. An air hose 18 is joined to the canister 16. The canister 16 is coupled to a purge VSV(Vacuum Switching Valve) 20 through a purge hose 19 and also to the throttle valve through a VSV purge hose 21. The purge hose 19 is secured to an intake manifold 23 through a purge hose clamp 22.

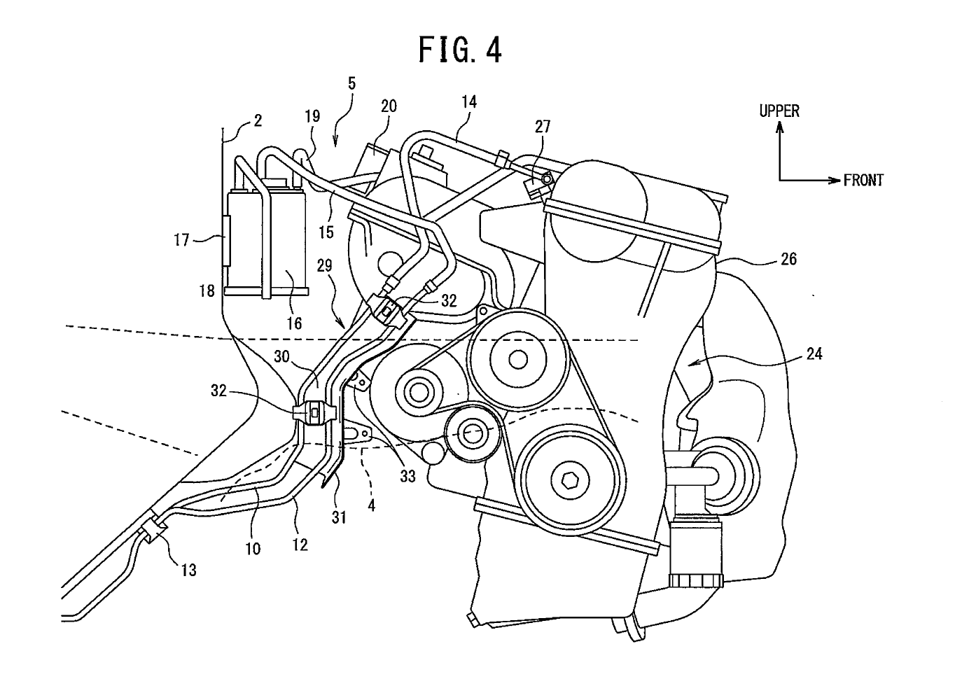

FIG. 3 is a plan view which illustrates the inside of the engine compartment 5. FIG. 4 is a side view of the engine compartment 5, as viewed from the right of the vehicle. A parallel four-cylinder engine 24 is mounted in the engine compartment 5. A transmission 25 is disposed on the left side of the engine 24. The engine 24 has a cylinder head 26 attached to an upper portion thereof. The intake manifold 23 is joined to the cylinder head 26. The delivery pipe 27 is laid over the cylinder head 26 (i.e., a cylinder head cover) and, as described above, coupled to the fuel pipe 10 through the fuel hose 14. The delivery pipe 27 serves to distribute the fuel to the respective cylinders of the engine 24. Fuel injectors 28 (i.e., a fuel injection system) are located just beneath the delivery pipe 27.

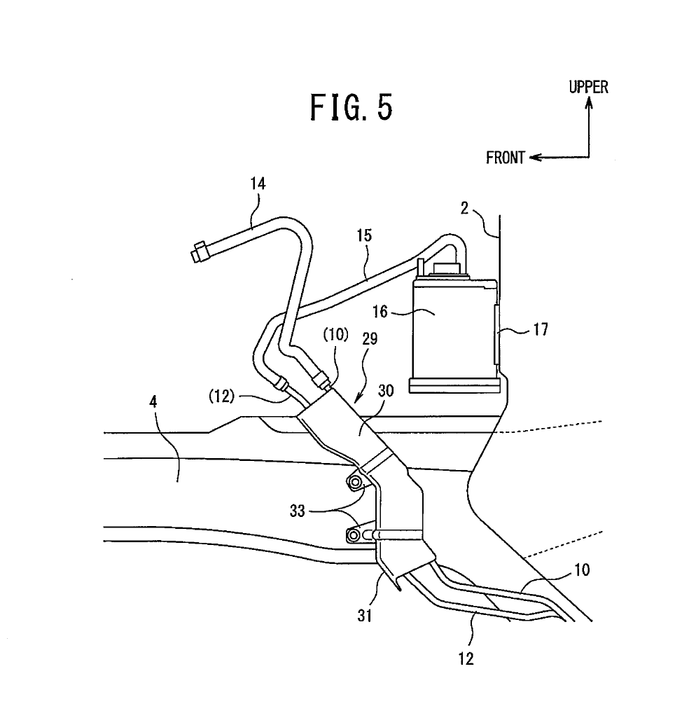

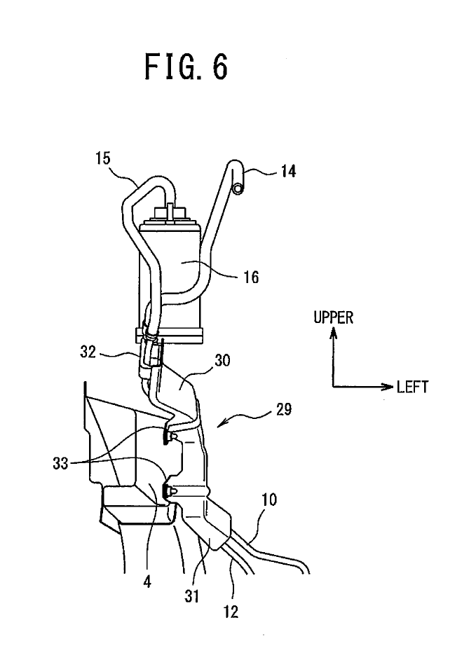

The fuel pipe 10 and the fuel vapor pipe 12 are fixed to a right one of the side frames 4 through a fuel pipe cover 29. FIG. 5 is a side view of the left of the fuel pipe cover 29 secured to the side frame 4. FIG. 6 is a front view of the fuel pipe cover 29. The fuel pipe cover 29 is formed by pressing a single metallic plate and has a first protective wall 30 which faces an inner side surface of the side frame 4 which is exposed to the engine compartment 5. The first protective wall 30 extends along the fuel pipe 10 and the fuel vapor pipe 12. The fuel pipe cover 29 also includes a second protective wall 31 which continues from a lower edge of the first protective wall 30 and extends or projects toward the inner side surface of the side frame 4. The second protective wall 31 has two mount tabs 33 which extend from a lower edge thereof along the inner side surface of the side frame 4 and are used in installing the fuel pipe cover 29 on the side frame 4. The mount tabs 33 extend substantially parallel to the inner side surface of the side frame 4. The side frame 4 has two studs with threaded heads which protrude inside the engine compartment 5. The installation of the fuel pipe cover 29 on the side frame 4 is achieved by inserting the studs of the side frame 4 into holes of the mount tabs 33 and then fastening nuts to the heads of the studs.

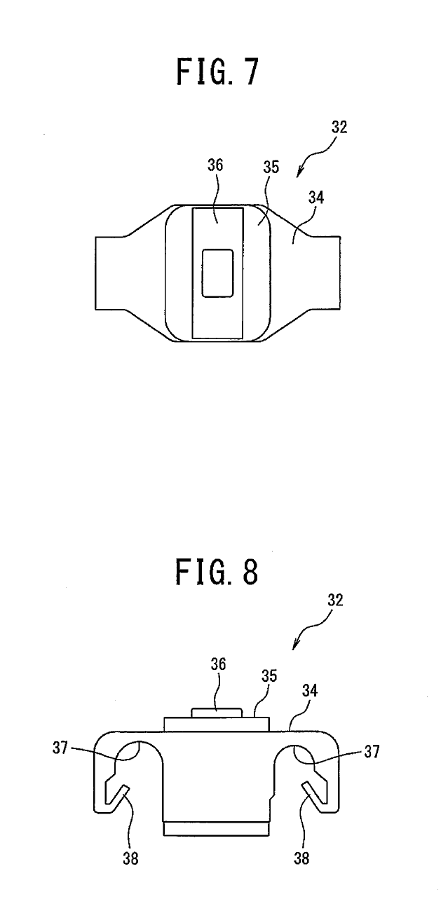

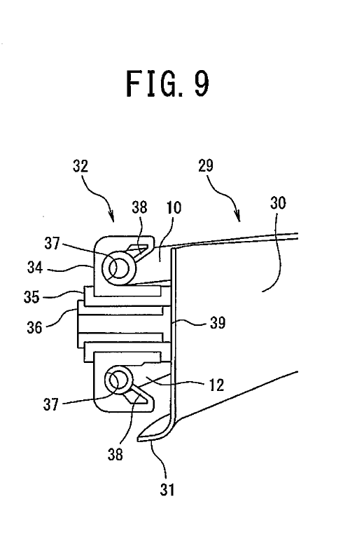

The first protective wall 30 of the fuel pipe cover 29 has a side frame opposing face facing the side frame 4. The side frame opposing face of the first protective wall 30 has affixed thereto, as illustrated in FIGS. 1 and 4, two pipe holders 32, respectively, which retain the fuel pipe 10 and the fuel vapor pipe 12 on the fuel pipe cover 29. FIG. 7 is a plan view which shows one of the pipe holders 32. FIG. 8 is a front view of the pipe holder 32 of FIG. 7. FIG. 9 is a vertical sectional view which illustrates the fuel pipe 10 and the fuel vapor pipe 12 grasped by the pipe holders 32. Each of the pipe holders 32 includes a resinous holding portion 34, a rubber member 35, a resinous collar 36. The holding portion 34 is so shaped as to grip the fuel pipe 10 and the fuel vapor pipe 12 directly. The rubber member 35 is fit in a center hole of the holding portion 34. The collar 36 is fit in a center hole of the rubber member 35. The holding portion 34 has recesses 37 into which circumferences of the fuel pipe 10 and the fuel vapor pipe 12 are to be put in a radial direction thereof, respectively. The holding portion 34 also has claws 38 which establish snap-fits of the fuel pipe 10 and the fuel vapor pipe 12 in the recesses 37 and elastically press the circumferences of the fuel pipe 10 and the fuel vapor pipe 12 against inner walls of the recesses 37. The collar 36 has a serrated protrusion formed on an inner wall of the hole thereof. The first protective wall 30 of the fuel pipe cover 29 has studs 39 joined to the side frame opposing face thereof. The studs 39 have external threads. The attachment of the fuel pipe 10 and the fuel vapor pipe 12 to the fuel pipe cover 29 is achieved by snap-fitting the fuel pipe 10 and the fuel vapor pipe 12 into the holding portions 34 of each of the pipe holders 32 and then putting the collar 36 on a corresponding one of the studs 39 to establish firm engagement of the serrated protrusion of the collar 36 with the external thread of the stud 39. The upper end of the fuel pipe cover 29 is located above the upper ends of the side frames 4. The fuel pipe cover 29 has an upper end which opens toward the front of the vehicle.

Usually, operating noise (i.e., pulsating nose) emitting from each of the fuel injectors 28 is transmitted to the delivery pipe 27, to the fuel hose 14, and then to the fuel pipe 10. The noise arising from flow of the fuel fed by the fuel pump 7 is also transmitted to the fuel pipe 10. The operating noise (i.e., pulsating noise) emanating from the purge VSV 20 is propagated to the purge hose 19, to the canister 16, to the fuel vapor hose 15, and then to the fuel vapor pipe 12. The fuel pipe 10 and the fuel vapor pipe 12 are, as described above, not attached directly to the side frame 4 through, for example, clamps, but secured to the fuel pipe cover 29 which is, in turn, joined to the side frame 4. The mechanical vibration or noise of the fuel pipe 10 and the fuel vapor pipe 12 are, therefore, hardly transmitted to the side frame 4 and then to the cabin of the vehicle.

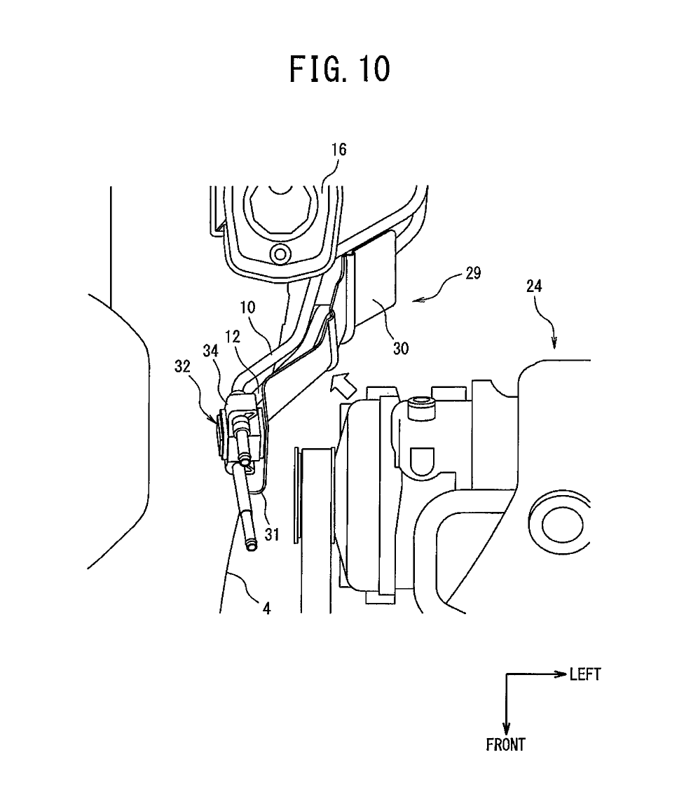

When external force is exerted on the front of the vehicle in the forward-backward direction thereof, it may cause the engine 24, as illustrated in FIG. 10, to be moved in a direction, as indicated by an arrow. The engine 24 first contacts with the fuel pipe cover 29, thereby avoiding direct contact with the fuel pipe 10 or the fuel vapor pipe 12. This minimizes deformation of the fuel pipe 10 or the fuel vapor pipe 12. The first protective wall 30 and the second protective wall 31 of the fuel pipe cover 29 are interposed between the engine 24 and the assembly of the fuel pipe 10 and the fuel vapor pipe 12, thereby thermally isolating the fuel pipe 10 and the fuel vapor pipe 12 from the engine 23 to minimize a rise in temperature thereof.

As apparent from the above discussion, the engine 24 is mounted in the engine compartment 5 defined by the side frames 4 and the dash panel 2. Each of the fuel pipe 10 and the fuel vapor pipe 12 has at least a portion which extends from below the dash panel 2 upwardly to the upper portion of the engine compartment 5 and is secured to one of the side frames 4 using the fuel pipe cover 29 within the engine compartment 5. The pipe attachment includes the fuel pipe cover 29 and the pipe holders 32. The fuel pipe cover 29 includes the first protective wall 30, the second protective wall 31, and the two pipe holders 32. The first protective wall 30 faces the inner side surface of the side frame 4 and extends along the length of each of the fuel pipe 10 and the fuel vapor pipe 12. The second protective wall 31 continues from the first protective wall 30 and projects toward the side frame 4. The pipe holders 32 are attached to the side frame opposing face of the first protective wall 30 which faces the side frame 4 and tightly clamp the fuel pipe 10 and the fuel vapor pipe 12. The fuel pipe cover 29 is, as can be seen in FIG. 1, placed between the mechanical joint of the fuel pipe 10 and the fuel vapor pipe 12 to the dash panel 2 and the ends of the fuel pipe 10 and the fuel vapor pipe 21 which are disposed inside the engine compartment 5. The fuel pipe cover 29 with the fuel pipe 10 and the fuel vapor pipe 12 firmly retained by the pipe holders 32 is fixed to the side frames 4. This minimizes the transmission of mechanical vibration or noise from the fuel pipe 10 or the fuel vapor pipe 12 to the cabin of the vehicle and also results in a reduced number of parts used to secure the fuel pipe 10 and the fuel vapor pipe 12 to the side frame 4 and a decreased production cost thereof as compared with the case where the fuel pipe 10 and the fuel vapor pipe 12 are joined to the side frame 4 using clamps. When external force acts on the vehicle, so that the engine 24 is, as described above, moved in the backward direction of the vehicle, it contacts the fuel pipe cover 29 without direct contact with the fuel pipe 10 or the fuel vapor pipe 12, thereby minimizing the deformation of the fuel pipe 10 and the fuel vapor pipe 12. The fuel pipe cover 29 also works to shield the fuel pipe 10 and the fuel vapor pipe 12 thermally from the engine 24 to minimize a rise in temperature of the fuel pipe 10 and the fuel vapor pipe 12. The attachment of the fuel pipe 10 and the fuel vapor pipe 12 to the side frame 4 using clamps results in a limited degree of freedom in designing the fuel pipe 10 and the fuel vapor pipe 12, while the use of the fuel pipe cover 29 offers a high degree of freedom in designing the fuel pipe 10 and the fuel vapor pipe 12 because it is easy to contour the fuel pipe cover 29, especially the second protective wall 31 to the outline of the fuel pipe 10 and the fuel vapor pipe 12.

The upper portion of the fuel pipe cover 29 is placed above the upper surface of the side frame 4. An upper one of the pipe holders 32 is joined to the upper portion of the fuel pipe cover 29 which extends above the side frame 4. In other words, the pipe holder 32 is located away from the side frame 4, thereby improving the degree of freedom of layout of the fuel pipe 10 and the fuel vapor pipe 12 and attachment thereof to the side frame 4 and also permitting the joint of the fuel pipe 10 and the fuel vapor pipe 12 to the side frame 4 to be located closer to a vibrating source, i.e., the engine 24. This minimizes the transmission of the vibration or noise to the cabin of the vehicle through the fuel pipe 10 and the fuel vapor pipe 12.

The fuel pipe cover 29, as described above, has the upper end which opens toward the front of the vehicle. The wind is, thus, introduced into the fuel pipe cover 29 while the vehicle is moving, thereby facilitating cooling of the fuel pipe 10 and the fuel vapor pipe 12 to avoid a rise in temperature thereof.

The number of the pipe holders 32 is not limited to two. One or three or more pipe holders 32 may be used to retain the fuel pipe 10 and the fuel vapor pipe 12. The fuel pipe cover 29 and at least one of the pipe holders 32 may be used to attach at least one of the fuel pipe 10 and the fuel vapor pipe 12 to the side frame 4. For instance, only the pipe holder 32 of the second protective wall 31 may be used to retain either of the fuel pipe 10 and the fuel vapor pipe 12.

What is claimed is:

1. A pipe attachment for use in attaching a pipe through which fuel flows to a side frame of a vehicle, the vehicle including an engine compartment in which an engine is mounted and a dash panel disposed on a rear side of the engine compartment in a forward-backward direction of the vehicle, the side frame extending in the forward-backward direction of the vehicle, the pipe being joined to the dash panel and having at least a portion extending from below the dash panel to an upper portion of the engine compartment, comprising:
a pipe cover which is secured to the side frame and disposed between a joint of the pipe to the dash panel and an end of the pipe which is located inside the engine compartment;
a first protective wall which is a portion of the pipe cover, the first protective wall extending along the pipe and facing a side surface of the side frame which faces the engine compartment;
a second protective wall which is a portion of the pipe cover, the second protective wall continuing from the first protective wall and projecting toward the side frame; and
at least one pipe holder which is secured to a surface of the first protective wall which faces the side frame and retains the pipe.

2. A pipe attachment as set forth in claim 1, wherein the pipe cover has an upper portion located above an upper surface of the side frame, and wherein the pipe holder is joined to the upper portion of the pipe cover.

3. A pipe attachment as set forth in claim 1, wherein the pipe cover has an upper end which opens to a front of the vehicle.
